(19) United States
(12) Patent Application Publication
(10) Pub. No.: US 2009/0260050 A1
(43) Pub. Date: Oct. 15, 2009

(54) Authenticating device for controlling application security environments

(76) Inventors: George Madathilparambil George, Hyderabad (IN); Nikhil George, Hyderabad (IN)

Correspondence Address: GEORGE MADAT-H-ILPARAMBIL GEORGE, 1208, Block 1, Naren''s SMR Vinay City, Bollaram Road, Miyapur, Hyderabad, 500049, IN

(21) Appl. No.: 12/082,606

(22) Filed: Apr. 14, 2008

(51) Int. Cl. G06F 21/00

(52) U.S. Cl. 726/1

(57) ABSTRACT

Computer protection is weak with the methods currently available and there are risks of malicious users getting access to computers, corrupting important data, including system data. We are proposing a method for improving access protection, more particularly, by adding a device capable of user authentication that will enable or disable protection for applications as required. The device supports one or more users, none or more user groups, none or one or more Application Security Environments for each user or user group and one or more states for each Application Security Environment. The state of the hardware is manually controlled by the users. Depending on the configuration, each hardware state corresponding to an Application Security Environment corresponds to a set of privileges for processes running in that Application Security Environment while that Application Security Environment is in that state.

### BACKGROUND OF THE INVENTION

The present invention relates to creating one or more highly secure application security environments in computing systems. An Application Security Environment is an environment in which a user or a group of users can run one or more tasks or one or more processes or one or more applications and in which privileges of the tasks or processes or applications run by a user or a user group can be more constrained than the privileges of the user or the user group. An application could consist of one or more tasks or processes. A process could consist of one or more threads.

Current technologies provide protection using operating system software and a malicious program or user can get access as a privileged user with limited access restrictions and run programs on behalf of other users or read confidential user data or corrupt user data. It requires hardware support to provide complete protection for user data from malicious programs.

There are different methods for access control such as non-privileged users in UNIX or Windows operating systems who cannot execute privileged instructions or access all parts of volatile or non-volatile memories (storage). But a malicious program or user can sometimes exploit security weaknesses in an operating system, to get access as a privileged user. This will allow malicious users to impersonate privileged users and gain access to critical data belonging to other users or corrupt users' data. UNIX and Windows security system does not allow limiting privileges assigned to a privileged user.

High level of application protection is provided by Application Security Environments such as Solaris containers and HPUX Security Containers. Each container ideally has only a subset of the privileges and compromising security of most of the containers poses only a limited risk. However, when either the operating system security is compromised or when the security of a container that is used to create other containers is compromised, it will result in significant risk to both computer users' identity and data.

There is a serious risk to users' data and users' identity when their laptops are stolen or when someone gains access to a user's computer in the user's absence.

There is a serious risk to users' data and users' identity when a privileged user is malicious. The privileged user may create containers that compromise both users' identity and users' data.

There are many methods for protecting computer users and user data which do not require manual action for enabling and disabling protection; Such protections can be compromised by malicious privileged users or by malicious programs by emulating the required software behavior.

U.S. Pat. No. 6,330,648 illustrates a method of adding protection against malicious programs using a manually controlled hardware with two states. By default the protection is enabled and has a mechanism to manually switch off the protection. This invention will not be able to provide protection for portions of storage belonging to each Application Security Environment, as is possible using our invention. Another drawback of the invention is that the solution cannot be used with mass memories which are already manufactured.

US Patent Application 20060117156 illustrates a method of adding protection for non-volatile memories against malicious programs using a manually controlled hardware with two or more states, but only two states are used for protection. One state has protection enabled and the other state has protection disabled. This invention will not be able to provide protection for portions of storage belonging to each Application Security Environment, as is possible using our invention.

U.S. patent application Ser. Nos. 11/514,807, 11/515,619 and 11/519,178 illustrate different manually controlled hardware solutions that protect data on mass-memories for each user. These patent applications propose dividing mass-memories into different areas and protecting these areas against malicious access. But these solutions cannot provide fine grained protection for each Application Security Environment. The privileges get enabled at user level and if any of the programs that are run by a user is malicious when the state corresponding to the user corresponds to low protection, it can cause serious risk to the user's data and user's identity.

FIG. 1 shows an example of a computer 101 with multiple users and multiple Application Security Environments each containing multiple processes. There are 3 Application Security Environments in the computer. Application Security Environment P 102 contains two processes A 105 and D 106. Application Security Environment Q 103 contains two processes C 107 and E 108. Application Security Environment R 104 contains two processes B 109 and F 110. The Application Security Environment P 102 and Q 103 are owned by User Y 111. The Application Security Environment R 104 is owned by User Group X 112.

### BRIEF SUMMARY OF THE INVENTION

It is the object of the present invention to use a device which supports user authentication and supports one or more Application Security Environments and supports one or more states for each Application Security Environment so that protection for the Application Security Environments can be improved. The device may be implemented in hardware or as a combination of hardware and firmware. This device is referred to as an Authenticating Application Security Environment Protection Device or AASEPDevice. The state of an Application Security Environment is referred to as Application Security Environment State. Each Application Security Environment is owned by a user or a group of users and only the owners of an Application Security Environment can run processes/tasks in that Application Security Environment. The privileges of the processes/tasks run in an Application Security Environment will be a subset of the privileges of the user or the user group who owns that Application Security Environment. The privileges of the processes/tasks run in an Application Security Environment will depend on the state of the Application Security Environment. The user or members of the user group who own an Application Security Environment are referred to as Application Security Environment Owners or ASEOs. Some users are grouped to create user groups. Each state of an Application Security Environment corresponds to or maps to a set of privileges that the processes/tasks/threads running in that Application Security Environment have when that Application Security Environment is in that state. This set of privileges corresponding to or mapped to an Application Security Environment State must be a subset of the privileges of the corresponding ASEOs. This mapping from a state of an Application Security Environment to a set of privileges that the processes/tasks/threads running in that Application Security Environment have when that Application Security Environment is in that state, is referred to as Application Security Environment State Mapping. Preferably, it requires a manual action on an AASEPDevice to:
i. Create or delete a user or
ii. Create or delete a user group or
iii. Add a user to or remove a user from a user group or
iv. Create or delete an Application Security Environment or
v. Create or delete an Application Security Environment State or
vi. Change the state corresponding to an Application Security Environment or
vii. Create or modify or delete an Application Security Environment State Mapping or
viii. Divide mass-memories into Regions which can be protected by AASEPDevices or
ix. Assign privileges to users and user groups including access to Regions of mass-memories.

These operations will be completed only if the user who makes the manual action is authenticated and has the required privileges. We refer to the manual action on the AASEPDevice to initiate these operations as Application Security Environment Protection Manual Action or ASEPManualAction.

The ASEPManualAction on an AASEPDevice may be pressing one or more buttons and/or toggling the position of one or more switches and/or turning a wheel and/or changing one or more jumper positions and/or any other manual action accepted by the AASEPDevice.

The AASEPDevice interacts with software running on the computer to which it is attached to perform these operations. This software is referred to as Application Security Environment Protection Software or ASEPSoftware.

As file system permissions and ownership are based on users and user groups, the protection provided for file operations will be based on users and user groups. The proposed invention does not handle protection for file system operations. All other privileged operations are handled by the proposed invention.

An AASEPDevice can be used for enforcing privileges for processes/tasks/threads in an Application Security Environment when the processes/tasks/threads do privileged operations such as executing a privileged instruction, making a privileged system call, calling a privileged function, accessing an area or a Region of mass-memories such as hard disc, DVD, etc. Privileged instructions include instructions to do an input/output operation to a device attached to the computer.

To protect data on mass-memories using an AASEPDevice, the mass-memories are divided into Regions or areas as proposed in U.S. patent application Ser. Nos. 11/514,807, 11/515,619 and 11/519,178. Read and write access to each Region is allowed or denied for each Application Security Environment based on the set of permissions that is mapped to the current state of the Application Security Environment.

The software, firmware and hardware that implement access protection fail a privileged operation which does not meet the access restrictions corresponding to the current state of the Application Security Environment from which the privileged operation is initiated. The software, firmware and hardware which implement access protection by checking the Application Security Environment State Mapping for the current state of an Application Security Environment is called Application Security Environment Protection Implementers or ASEPImplementers.

Preferably, a part of or all of the configuration required for enforcing protection based on the proposed invention must be kept in an AASEPDevice. These include the configuration for users, user groups, Application Security Environments, Application Security Environment States and Application Security Environment State Mappings.

### BRIEF DESCRIPTION OF THE SEVERAL VIEWS OF THE DRAWINGS

FIG. 1 illustrates a computer system with different Application Security Environments each owned by a user or a user group.

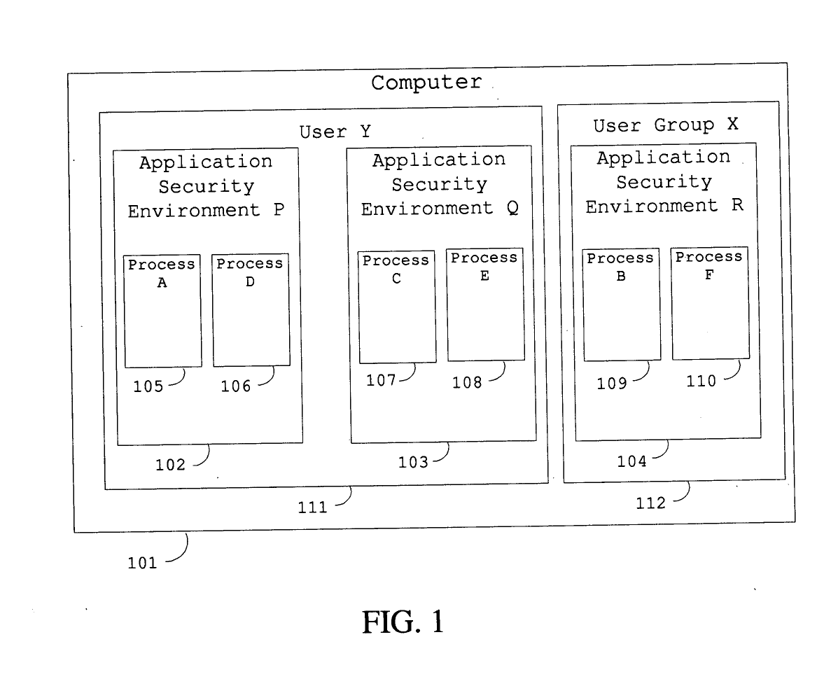

FIG. 2 illustrates an example of a state machine of an AASEPDevice that accepts ASEPManualAction.

FIG. 3 illustrates an example of a state machine of an AASEPDevice device driver that controls an AASEPDevice.

FIG. 4 illustrates an example of a state machine of ASEPSoftware which processes requests from an AASEPDevice device driver.

FIG. 5 illustrates an example of a state machine of an ASEPImplementer that implements access restrictions for Application Security Environments using an AASEPDevice.

FIG. 6 illustrates an example of how different components in a computer interact when used with an AASEPDevice that accepts ASEPManualActions.

FIG. 7 illustrates an example of a state machine of an AASEPDevice that handles conflicts between operations.

FIG. 8 illustrates an example of a state machine of an ASEPSoftware that can be used with an AASEPDevice that handles conflicts between operations.

### DETAILED DESCRIPTION OF THE INVENTION

According to the invention, one or more AASEPDevices or ASEPSoftware or a combination of one or more AASEPDevices and ASEPSoftware allow:
i. A privileged user to create or delete users;
ii. A privileged user to create or delete user groups;
iii. A privileged user to add users to or remove users from a user group;
iv. A privileged user to assign privileges for users or user groups;
v. A user to create or delete Application Security Environments owned by that user;
vi. All or some members of a user group to create or delete Application Security Environments owned by that user group;
vii. Some privileged users to create or delete Application Security Environments owned by a user or by a user group;
viii. A user to create or delete Application Security Environment States for an Application Security Environment owned by that user;
ix. All or some members of a user group to create or delete Application Security Environment States for an Application Security Environment owned by that user group;
x. Some privileged users to create or delete Application Security Environment States for an Application Security Environment;
xi. A user to create or modify or delete an Application Security Environment State Mapping for an Application Security Environment State for an Application Security Environment owned by that user;
xii. All or some members of a user group to create or modify or delete an Application Security Environment State Mapping for an Application Security Environment State for an Application Security Environment owned by that user group;
xiii. Some privileged users to create or modify or delete an Application Security Environment State Mapping for an Application Security Environment State for an Application Security Environment.

A user or user group can own none or one or more Application Security Environments.

An Application Security Environment can have one or more states. This allows privileges to be enabled for an Application Security Environment only when one or more Applications need to be run in that Application Security Environment. This significantly enhances the security of the computing systems. Similarly, this allows privileges to be enabled based on the requirements of the application being run in an Application Security Environment.

The state of an Application Security Environment can be changed only using an AASEPDevice.

The privileges of an Application Security Environment owned by an ASEO must be a subset of the privileges of that ASEO. Preferably, only an ASEO of an Application Security Environment should be allowed to configure access restrictions for that Application Security Environment corresponding to different states of that Application Security Environment.

The privileges assigned to different users or groups are not mutually exclusive.

When an Application Security Environment State Mapping is created, an ASEPSoftware or an AASEPDevice verifies whether the privileges corresponding to the Application Security Environment State exceed the privileges of the user or user group who owns that Application Security Environment. Preferably, if the privileges corresponding to an Application Security Environment State exceed the privileges of the user or user group who owns the Application Security Environment, the Application Security Environment State Mapping is discarded and the user who tried to create the mapping gets an error. Optionally, the privileges corresponding to an Application Security Environment State that exceed the privileges of the user or user group who owns the Application Security Environment are discarded and the rest of the mapping is allowed.

The configuration used by AASEPDevices and ASEPSoftware contains:
i. The list of users;
ii. The list of user groups;
iii. The list of users in each user group;
iv. The set of privileges each user or each user group has;
v. The list of Application Security Environments for each user and user group;
vi. The list of states for each Application Security Environment;
vii. The list of Regions of mass-memories which are protected by AASEPDevices;
viii. The Application Security Environment State Mapping for each Application Security Environment State;

The configuration may be stored in one or more AASEPDevices or one or more other devices which are attached to or are part of the computer. The device attached to the computer storing this configuration may be a mass-memory. Optionally, the configuration could be distributed among these devices. Optionally, two or more copies of the configuration could be on these devices.

Preferably, the configuration must be kept in AASEPDevices in registers/memory not writable by a computer and updates to the configuration must be allowed only through ASEPManualAction.

Optionally, if the configuration is kept in a Region of a mass-memory then preferably, only ASEPSoftware must have write access to that Region of mass memory.

Optionally, when the configuration can be changed without a user performing an ASEPManualAction, writes and reads of the configuration must be protected by ASEPImplementers and one or more AASEPDevices.

The verification performed by an ASEPImplementer to verify whether a process/task in an Application Security Environment can do a privileged operation may involve both reading registers/memory of an AASEPDevice to fetch the current state of the Application Security Environment and verification by the ASEPImplementer against the configuration. If the configuration is stored in an AASEPDevice, the ASEPImplementer can verify whether an operation is permitted by reading the AASEPDevice registers/memory. If the configuration is stored in a separate device, the ASEPImplementer must fetch the current state of the Application Security Environment and the Application Security Environment State Mapping for that state to determine whether the operation is permitted in the current state of that Application Security Environment. Preferably, every privilege has an identifier which makes searching for a given privilege in an Application Security Environment State Mapping simple.

Reading and writing to the configuration are privileged operations. Preferably, when the configuration is kept in AASEPDevices, only AASEPDevices must have write access to the configuration.

Preferably, write access to the configuration of an Application Security Environment must be given only to the owners (ASEOs) of that Application Security Environment.

Only one or more privileged users can have privileges to create or delete users or to create or delete user groups or to add or remove users to or from a user group or to assign privileges to users or user groups. Hence, preferably, write access to the configuration containing the list of users, the list of user groups, the list of users in each user group, the privileges of each user or each user group must be given only to one or more privileged users.

Optionally, when the configuration is not kept in AASEPDevices, only ASEPSoftware must have write access to the configuration.

When a user performs an ASEPManualAction, the operation corresponding to the ASEPManualAction and optionally, an identifier for the user who performed the ASEPManualAction are placed in registers/memory readable by the computer to which the AASEPDevice is attached.

The ASEPImplementers must be capable of identifying the Application Security Environment from which a process/task/thread is attempting to execute a privileged instruction/function/system call or access portions of mass memories. Optionally, the operating system should be able to tag every privileged operation with the identifier of the Application Security Environment from which the privileged operation is being executed.

For most of the operations requested by users through ASEPManualActions, the ASEPSoftware needs to do a cleanup and update of data structures before an AASEPDevice is allowed to complete those operations. The cleanup may involve flushing dirty buffers in file system buffer caches and/or cleaning up data structures.

For example, the ASEPSoftware may need to flush dirty buffers in file system buffer caches and/or clean up data structures corresponding to the old privileges as the new set of privileges may block access to these buffers and data for processes/tasks/threads in the Application Security Environment.

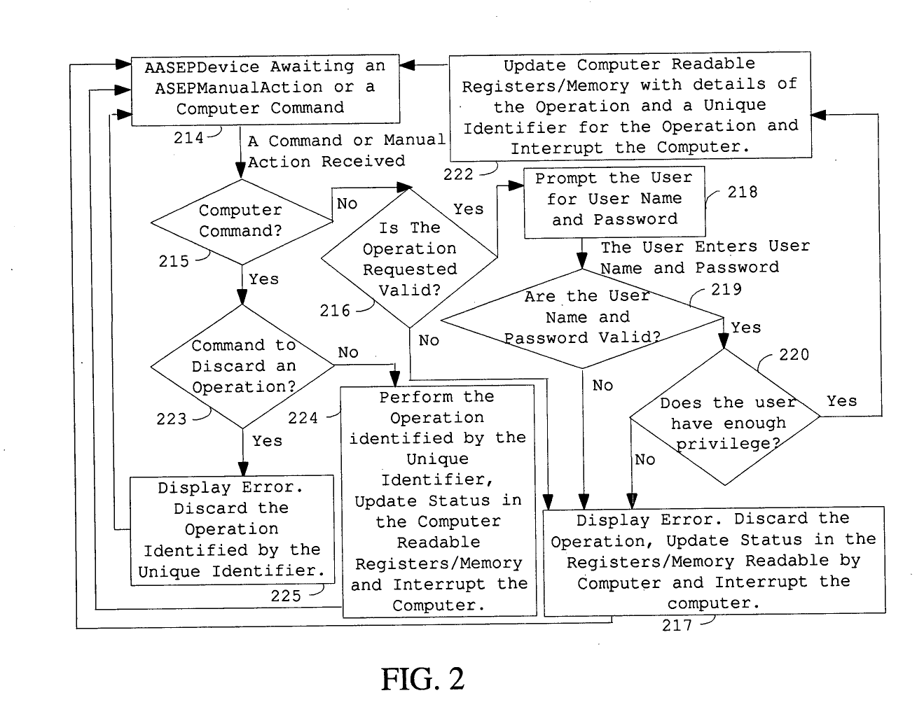

FIG. 2 illustrates an example of a state machine of an AASEPDevice that accepts ASEPManualAction. The configuration is stored in this AASEPDevice and hence the firmware running on the AASEPDevice can determine whether an operation requested by an ASEPManualAction is valid or not. The AASEPDevice awaits 214 ASEPManualAction from a user or a Computer Command from the computer to which it is attached. The AASEPDevice checks the type of input 215, whether an ASEPManualAction or a Computer Command is received. When a user performs an ASEPManualAction, the AASEPDevice checks 216 whether the operation requested by the user by performing the ASEPManualAction is valid. If the operation requested is invalid 217, the AASEPDevice displays an error message for the invalid operation, discards the operation, updates registers/memory readable (but not writable by the computer) by the computer to indicate the discarded operation and the reason for discarding the operation and interrupts the computer to which it is attached. If the operation is valid 218, the AASEPDevice prompts 218 the user who performed the ASEPManualAction for the user name and password. When the user enters the user name and password, the user name and password are validated 219. If the validation fails 217, the AASEPDevice displays an error message, discards the operation, updates registers/memory readable (but not writable by the computer) by the computer to indicate the discarded operation and the reason for discarding the operation and interrupts the computer to which it is attached. If the user name and password are valid, the ASEPSoftware checks whether the user has the privilege 220 to perform the operation requested by the user by performing the ASEPManualAction. If the user does not have the required privilege 217, the AASEPDevice displays an error message, discards the operation, updates registers/memory readable (but not writable by the computer) by the computer to indicate the discarded operation and the reason for discarding the operation and interrupts the computer to which it is attached. If the user has the required privilege to perform the operation 222, the AASEPDevice updates Computer Readable (but not computer writable) Registers/Memory with details of the operation requested through the ASEPManualAction and a unique identifier for the operation and interrupts the Computer to which it is attached. When a Computer Command is received, the AASEPDevice checks 223 whether the command is to discard or perform an operation. If the command is to discard an operation 225, the AASEPDevice displays an error message and discards the operation identified by the unique identifier. If the command is to perform an operation, the AASEPDevice performs 224 the operation identified by the unique identifier, updates registers/memory readable (but not writable) by the computer with the status and results of the operation and interrupts the computer to which it is attached.

If the configuration containing the Application Security Environment State Mappings is stored in the AASEPDevice and the operation requested by performing an ASEPManualAction is for an Application Security Environment State change, the AASEPDevice can update registers/memory with the new privileges that the processes/tasks running in the Application Security Environment have, as part of performing the operation.

The ASEPManualAction on an AASEPDevice may be pressing one or more buttons and/or toggling the position of one or more switches and/or turning a wheel and/or changing one or more jumper positions and/or any other ASEPManualAction supported by the AASEPDevice. Preferably, every AASEPDevice has a display screen where the user can see the inputs the user has entered.

The AASEPDevice may use registers or memory readable by the computer to communicate the operation requested by a user by performing an ASEPManualAction. Preferably, a computer should not be allowed to write into these registers or memory locations. This improves security as a malicious software will not be able to manipulate the operation requested by a user by performing an ASEPManualAction.

An ASEPManualAction can be for:
i. Creating or deleting one or more users or
ii. Creating or deleting one or more user groups or
iii. Creating or deleting one or more Application Security Environments owned by a user or a user group or
iv. Creating or deleting one or more Application Security Environment States for an Application Security Environment or
vii. Dividing mass-memories into Regions which can be protected by AASEPDevices or
viii. Assigning privileges to users and user groups including access to Regions of mass-memories or
v. Adding users to or removing users from a user group or
vi. Changing the state of an Application Security Environment or
ix. Creating or modifying or deleting Application Security Environment State Mappings for an Application Security Environment.

A privileged user can perform an ASEPManualAction to:
i. Create or delete one or more users or
ii. Create or delete one or more user groups or
iii. Add one or more users to or remove one or more users from a user group or
iv. Assign privileges to one or more users or user groups or
v. Create or delete one or more Application Security Environments owned by a user or a user group or
vi. Create or delete one or more Application Security Environment States for an Application Security Environment or
vii. Change the state of an Application Security Environment or
viii. Divide mass-memories into Regions which can be protected by AASEPDevices or
ix. Create or modify or delete one or more Application Security Environment State Mappings for an Application Security Environment.

A user can perform an ASEPManualAction to:
i. Create or delete one or more Application Security Environments owned by that user or by one of that user's groups or
ii. Create or delete one or more Application Security Environment States for an Application Security Environment owned by that user or by one of that user's groups or
iii. Change the state of an Application Security Environment owned by that user or by one of that user's groups or
iv. Create or modify or delete one or more Application Security Environment State Mappings for an Application Security Environment owned by that user or by one of that user's groups.

Optionally, some of the actions for each of the operations can be done using an AASEPDevice and the rest of the actions for the same operation can be done using ASEPSoftware.

Optionally, some of these operations can be done using ASEPSoftware and rest of the operations can be done by doing ASEPManualActions on AASEPDevices.

Optionally, an ASEPManualAction specifies only one operation such as adding one user or deleting one user, etc.

Optionally, when an ASEPManualAction specifies more than one operation, none of these operations will be allowed to proceed if the user does not have the privilege to perform any of those operations. This is not a recommended option.

Optionally, when an ASEPManualAction specifies more than one operation, only those operations will not be allowed to proceed for which the user does not have the privilege to perform the operations. This is not a recommended option.

For the rest of the description, it is assumed that an ASEPManualAction specifies only one operation; However, creating multiple users or creating multiple Application Security Environments for a user, etc. is considered a single operation.

When a new user or a new user group or a new Application Security Environment or a new Application Security Environment State is created, the AASEPDevice can allocate memory and create data structures for storing the corresponding information as part of performing the operation.

When a user or a user group or an Application Security Environment or an Application Security Environment State is deleted, the AASEPDevice can deallocate the corresponding memory and update the corresponding data structures as part of performing the operation.

When an Application Security Environment State Mapping is changed, the AASEPDevice can update internal data structures corresponding to that mapping and also update registers/memory containing the current set of privileges for the Application Security Environment based on its current state. The updates done by an AASEPDevice as part of performing an operation are implementation specific.

Invalid operations include adding a user to a non-existent user group, creating an Application Security Environment for a non-existent user or for a non-existent user group, creating a new state for a non-existent Application Security Environment, creating an Application Security Environment State Mapping for a non-existent Application Security Environment State, creating or modifying Application Security Environment State Mapping such that the privileges corresponding to an Application Security Environment State exceeds the privileges of the corresponding ASEOs, etc.

The ability of an AASEPDevice to detect invalid operations is implementation specific. Optionally, ASEPSoftware can be used for detecting some or all invalid operations. Optionally, ASEPSoftware can use a peripheral device other than the AASEPDevice for detecting invalid operations.

The set of operations supported by an AASEPDevice is implementation specific. But all AASEPDevices must support one or more Application Security Environments and one or more states for each Application Security Environment.

Different AASEPDevices could have different behaviors while accepting user-names and passwords. If the user-name/password entered by a user is invalid, the AASEPDevice could prompt the user for the user-name/password again and accept a new user-name/password from the user until a valid user-name/password is received or until the maximum number of password retries is reached or until the user cancels the request to reenter the password. The AASEPDevice that supports user-name/password retries, will discard an operation corresponding to an ASEPManualAction due to user authentication failure only if a valid user-name/password is not received even after the maximum number of user-name/password retries or if the user cancels the password retry.

The method used by an AASEPDevice for authenticating a user using user-name/password or password is implementation specific.

An AASEPDevice may use other options for authenticating a user, such as finger print validation, retina validation, or other current and future technologies for user authentication. An AASEPDevice may also use a combination of two or more methods of user authentication such as user-name validation, password validation, finger print validation, retina validation, etc., for authenticating the user who performed an ASEPManualAction. The method used by an AASEPDevice for authenticating a user is implementation specific.

Some AASEPDevices may use a timeout while performing user authentication. In this case, the AASEPDevice will fail the user authentication and discard the operation after the timeout expires.

The order in which the validation of an operation, the user authentication for an operation, the check to verify whether the user has sufficient privileges to do the operation and the check to detect/resolve whether the operation has conflict with any ongoing operations are done, is implementation specific.

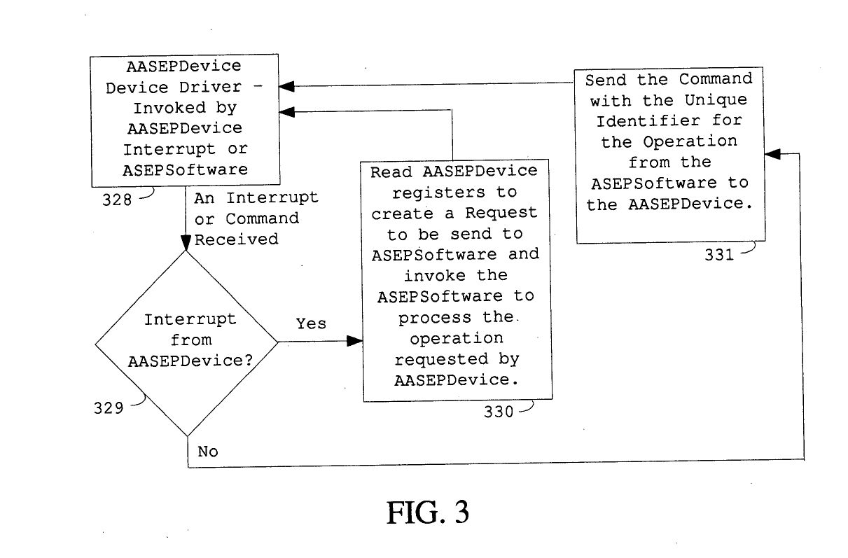

FIG. 3 illustrates an example of a state machine of an AASEPDevice device driver. The AASEPDevice device driver awaits 328 an interrupt from an AASEPDevice or a command from ASEPSoftware. The AASEPDevice device driver checks 329 whether it got invoked due to an interrupt or due to a command sent by the ASEPSoftware. When an interrupt is received from the AASEPDevice 330, the device driver reads AASEPDevice registers and memory to create a request to be passed to the ASEPSoftware. Then it invokes the ASEPSoftware to process the request. When the ASEPSoftware invokes 331 the AASEPDevice device driver by sending a command, the driver sends the command to the AASEPDevice by writing into the AASEPDevice registers/memory.

An AASEPDevice device driver may control one or more AASEPDevices. There could be one or more AASEPDevice device drivers running on a computer, each controlling a mutually exclusive set of AASEPDevices.

Preferably, most of the ASEPSoftware should be part of the operating system.

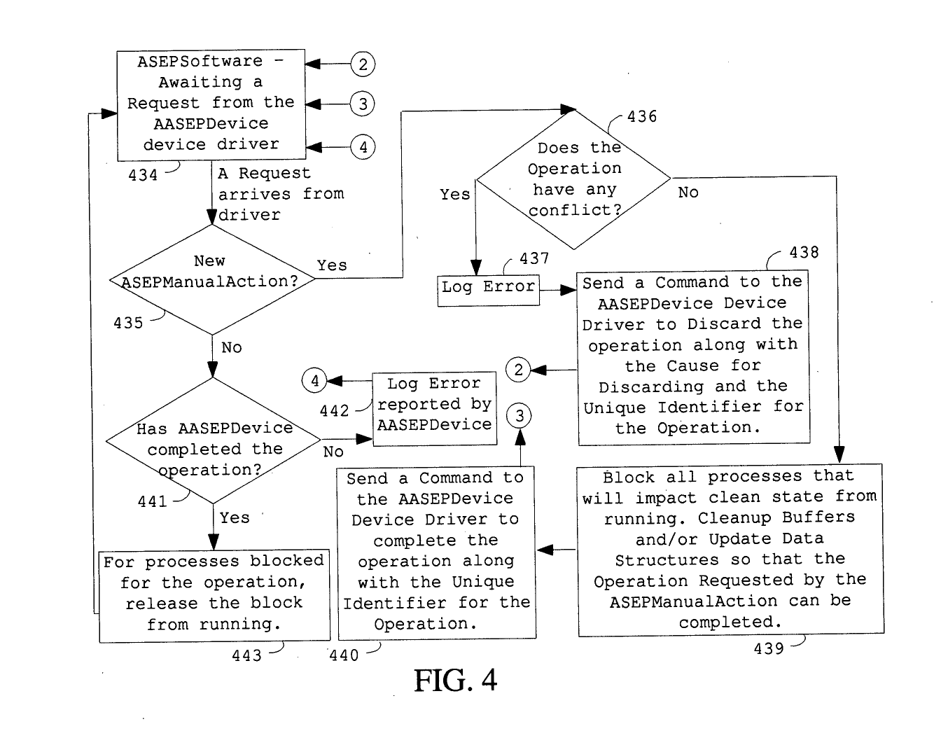

FIG. 4 illustrates an example of a state machine of the ASEPSoftware that processes requests from an AASEPDevice device driver. The ASEPSoftware 434 awaits requests from the AASEPDevice device driver. When a request from the AASEPDevice device driver arrives, the ASEPSoftware checks whether the request is for an operation corresponding to a new ASEPManualAction 435. If the request is for an operation corresponding to a new ASEPManualAction, the ASEPSoftware checks whether the requested operation has any conflict 436 with any of the ongoing operations. If there is a conflict, the ASEPSoftware logs an error message 437 and sends a command 438 along with the unique identifier for the operation to the AASEPDevice device driver to discard the operation and goes back to the state where it awaits a new request from the AASEPDevice device driver. If the operation requested does not have any conflict with ongoing operations, the ASEPSoftware performs the cleanup 439 required to perform the operation including cleaning up of buffers and updating data structures as required. As part of the cleanup, all processes that will impact the clean state are blocked from running 439. The ASEPSoftware may interact with other operating system modules to get the required cleanup completed. After the clean up is completed, ASEPSoftware sends a command 440 to the AASEPDevice device driver with the unique identifier for the operation so that the AASEPDevice can perform the operation and goes back to the state where it awaits a new request from the AASEPDevice device driver. In this state 440, ASEPSoftware does not release the not-ready-to-run state for processes that will impact the clean state. If the request from the AASEPDevice device driver is not for a new ASEPManualAction 441, ASEPSoftware checks whether the AASEPDevice has completed an operation. When an operation is completed 443, for all the processes that were blocked from running for that operation to complete, the ASEPSoftware releases the block and goes back to the state where it awaits a new request from the AASEPDevice device driver. If the request from the AASEPDevice device driver is to indicate that a user entered an invalid operation or that user authentication for an ASEPManualAction failed or that user does not have the privilege required to perform an operation requested by an ASEPManualAction, the ASEPSoftware logs 442 the error message and goes back to the state where it awaits a new request from the AASEPDevice device driver.

The ASEPSoftware could consist of different components such as configuration commands, operating system modules that create/delete/update data structures and configuration for users, user groups, Application Security Environments, Application Security Environment States and Application Security Environment State Mappings.

If the operation requested by an ASEPManualAction is to delete a user, preferably, all the processes/tasks owned by the user will be terminated and all data structures for the Application Security Environments owned by that user will be deleted as part of the cleanup. If the operation requested by an ASEPManualAction is to delete an Application Security Environment, preferably, all the processes/tasks in the Application Security Environment will be terminated as part of the clean up. If the operation requested by an ASEPManualAction is to delete a state of an Application Security Environment and if the current state of the Application Security Environment is the same as the state being deleted, it is considered an invalid operation. If the operation requested is a change of Application Security Environment State, all processes/tasks in that Application Security Environment must be prevented from running and those processes/tasks are allowed to run again only after the state change is completed by the AASEPDevice. A process or a task could be blocked for more than one operation to complete and it will be allowed to run only after all those operations are complete. If the operation requested by an ASEPManualAction is to lower the privileges corresponding to a user or a user group, then the set of privileges corresponding to the Application Security Environment States of the Application Security Environments which are owned by that user or that user group will be also be lowered accordingly, by ANDing with the new set of privileges for the user or the user group.

Optionally, when an operation requested by an ASEPManualAction is to delete a user and if that user has processes/tasks which are active, the operation can be discarded as a conflicting operation.

The ASEPSoftware may use different strategies to resolve conflict between a new operation and ongoing operations such as queuing all new operations that have a conflict with an ongoing operation and using different levels of priority. If operations have priorities and if a conflicting low priority operation is in a state where it can be stopped, a new high priority operation can result in the ongoing low priority operation to be marked to be stopped and the high priority operation can be kept pending until the ongoing operation is stopped. The strategy used for resolving conflict between ongoing operations and a new operation is implementation specific.

As part of cleanup for an operation, all the processes/tasks that will affect the clean state required for that operation must be stopped from running.

Examples of operations that require cleanup/update by an ASEPSoftware are the creation/deletion of one or more users or user groups or Application Security Environments or Application Security Environment States or, adding/deleting one or more users to or from a user group or, changing the state corresponding to an Application Security Environment or, changing the privileges of a user or a user group or, modifying the Application Security Environment State Mappings for the current Application Security Environment State.

In order to protect data on mass-memories, the mass-memories are divided into Regions and read or write access to each Region is controlled for each user and each user group. Privileged users limit read or write access to each user or user group to these Regions as proposed in U.S. patent application Ser. Nos. 11/514,807, 11/515,619 and 11/519,178. Users can further limit access to each Application Security Environment owned by them. These limits are applied in addition to the restrictions applied at file system level.

File systems and raw disk access system calls can tag each read or write operation with the identifier of the Application Security Environment from which the file operation or raw disk access is attempted. Each buffer in a buffer cache in a file system is tagged similarly to the proposal in U.S. patent application Ser. Nos. 11/514,807, 11/515,619 and 11/519,178. Each buffer can have multiple tags and each tag corresponds to an Application Security Environment. When a file operation done by a process/task maps to a buffer in the buffer cache, the file system checks whether the Application Security Environment already has an Application Security Environment tag to that buffer. If the Application Security Environment tag exists, the file system checks whether the operation requested by the file operation is permitted by the tag. If the file operation is not permitted, the file system returns an error to the process/task that requested the operation. If the Application Security Environment tag exists and the tag allows the file operation, the read or write to the buffer is allowed to proceed. If the Application Security Environment tag does not exist, the file system calls an ASEPImplementer with the identifier for the Application Security Environment and an identifier for the Region of the mass-memory. The ASEPImplementer checks the AASEPDevice registers/memory corresponding to the Region of the mass-memory and the Application Security Environment and creates an Application Security Environment tag. The Application Security Environment tag is returned to the file system. The file system adds the tag to the buffer and verifies whether the operation requested is permitted by the tag. If the Application Security Environment tag does not permit the requested operation, an error is returned to the process/task. If the Application Security Environment tag permits the operation, the operation is allowed to continue. If the buffer requested by a file operation does not exist, the file system gets an Application Security Environment tag for the buffer from the ASEPImplementer. If the operation is permitted, the file system creates a new buffer in its buffer cache, adds the Application Security Environment tag to the buffer and if required, creates a mass-memory read request for the buffer along with the tag. A mass-memory read request is required if the buffer is being read or is being partially written by the process/task. If the operation is not permitted by the Application Security Environment tag, an error is returned to the process/task and no new buffer will be created. The Application Security Environment tag is passed to storage components below the file system along with mass-memory read or write requests similar to the proposal in U.S. patent application Ser. Nos. 11/514,807, 11/515,619 and 11/519,178.

Before the state of an Application Security Environment can be changed, as part of cleanup, all the tags for that Application Security Environment should be removed from the buffers in the buffer cache in a file system. Similar cleanup will be required in all file systems in the operating system.

Similar cleanup is required when an Application Security Environment or an ASEO is deleted or when the privileges of an ASEO is changed or when the set of privileges corresponding to the current state of an Application Security Environment is modified.

There are different options for restarting processes/tasks which are blocked for cleanup. One option is to configure the AASEPDevice to generate an interrupt when an operation completes as shown in the examples. The processes/tasks in the Application Security Environment are blocked from executing until the interrupt is processed by the operation system. Another option is to use a timeout for an operation to complete and processes/tasks in the Application Security Environment are blocked from execution during the timeout period. If the operation does not complete during the timeout period, the user who initiated the ASEPManualAction can either abort the operation or initiate another timeout. This is not a recommended option. A third option is to use both the timeout and the interrupt for keeping the Application Security Environment in a clean state until state change is completed.

If the configuration is not kept in the AASEPDevices, validity of an operation will have to be verified by the ASEPSoftware. In this case, if the operation is invalid as per the configuration, the ASEPSoftware will send a command to the AASEPDevice to discard the operation.

Preferably, ASEPImplementers are computer software modules that implement access protection using AASEPDevice/s and create Application Security Environment tags for file systems. Preferably, all or most of the ASEPImplementers should be part of the operating system.

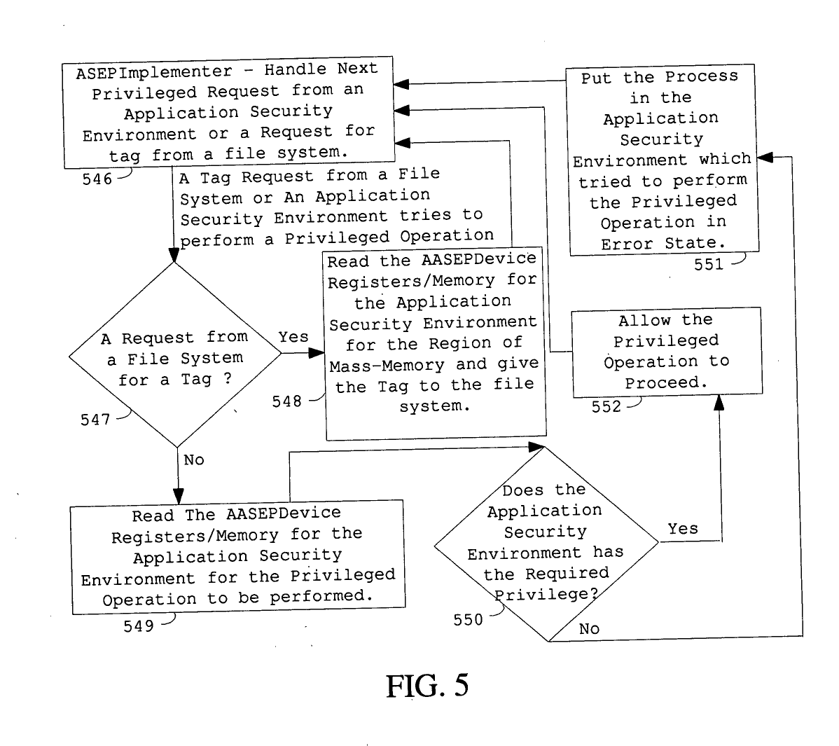

FIG. 5 illustrates an example of a state machine of an ASEPImplementer. The ASEPImplementer gets invoked 546 when a process or a task or a thread attempts to do a privileged operation or when a file system requests an Application Security Environment tag. The ASEPImplementer checks 547 whether it was invoked by a request from a file system for a tag. If it is a request from a file system 548, the ASEPImplementer reads read-only AASEPDevice registers/Memory corresponding to the Application Security Environment and the Region of mass-memory to create the tag. The tag is sent 548 to the file system and the ASEPImplementer returns. If the request is not a tag request from a file system, the ASEPImplementer checks 550 whether the process/task/thread that is attempting to do a privileged operation has the privilege to perform the privileged operation by reading 549 read-only registers/memory corresponding to the requested privileged operation for the Application Security Environment in which the process or task or thread is executing. If the Application Security Environment has the privilege 552 to perform the privileged operation in its current state, the process/task/thread is allowed to perform the privileged operation. If the Application Security Environment does not have the privilege 551 to perform the operation in its current state, the process/task/thread that attempted to do the privileged operation is placed in an error state and the ASEPImplementer returns. Handling of the process/task/thread in error state is done by the operating system.

If there is no configuration present for a privileged operation which is attempted by a process/task/thread in an Application Security Environment such as when there is no Application Security Environment State Mapping for the current Application Security Environment State or when there are no states defined for an Application Security Environment, preferably, ASEPImplementers must be configured to block the privileged operation. There could be some ASEPImplementers that are configured to allow the privileged operation when there is no configuration.

The ASEPImplementer may be designed such that it places an application in an error state when a process or a task or a thread in the application requests a privileged operation which is not allowed by the current state of the Application Security Environment. The way an ASEPImplementer handles a privileged operation failure is implementation specific.

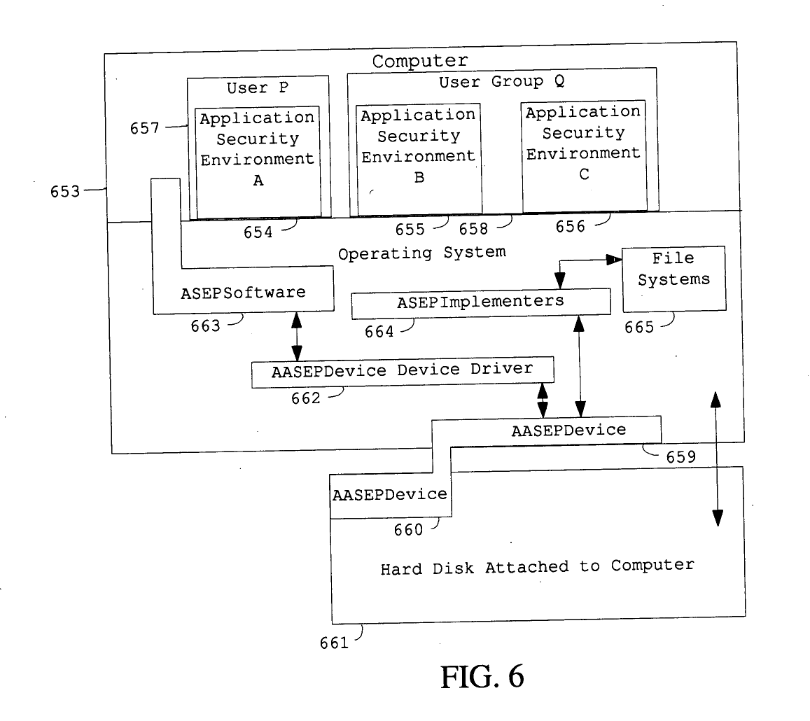

FIG. 6 illustrates an example of a computer 653 that implements access protection using an AASEPDevice. The computer has Application Security Environment A 654 which is owned by User P 657 and Application Security Environments B 655 and C 656 which are owned by User Group Q 658. An AASEPDevice 659 is attached to the computer 653. Part 660 of the AASEPDevice 659 is embedded in a hard disk 661 attached to the computer so that disk firmware can read AASEPDevice registers and memory without interacting with the computer or a link external to the disk. The AASEPDevice 659 is controlled by an AASEPDevice device driver 662. The AASEPDevice device driver 662 passes requests from the AASEPDevice 659 to the ASEPSoftware 663 and commands from the ASEPSoftware 663 to the AASEPDevice 659. Most of the ASEPSoftware is part of the operating system. A part of the software which writes errors to log files is part of the user space. ASEPImplementers 664 enforce access control by reading the AASEPDevice 659 registers/memory. File systems 665 interact with the ASEPImplementers 664 to get Application Security Environment tags.

ASEPImplementers can use AASEPDevice device driver interfaces for reading AASEPDevice registers/memory.

There are different ways to distribute functionality between AASEPDevices and ASEPSoftware. Optionally, ASEPSoftware can be used to verify whether an operation requested through an ASEPManualAction is valid. In this case, when an operation is not valid, ASEPSoftware can send a command to the AASEPDevice to discard the operation. Similarly, an AASEPDevice can be used to verify whether there is a conflict between a new operation requested by an ASEPManualAction and an ongoing operation. The distribution of functionality between ASEPSoftware and AASEPDevices is implementation specific.

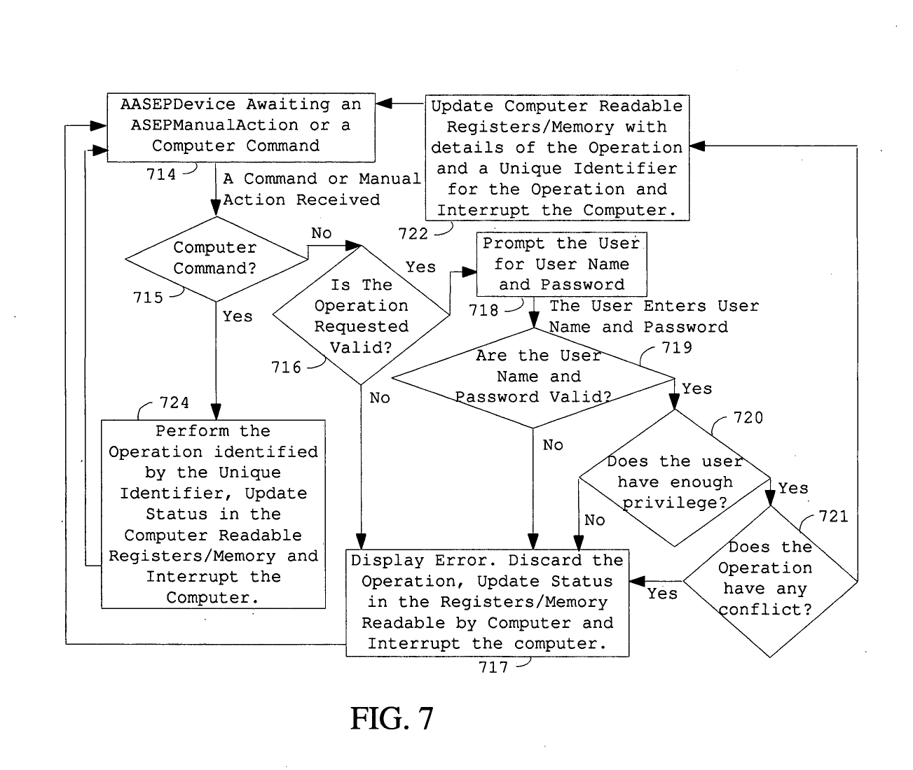

FIG. 7 illustrates an example of a state machine of an AASEPDevice that handles conflicts between operations. The configuration for users/user groups/Application Security Environments/Application Security Environment States is stored in this AASEPDevice and hence the firmware on the AASEPDevice can determine whether an operation requested by an ASEPManualAction is valid or not. The AASEPDevice awaits 714 ASEPManualAction from a user or a Computer Command from the computer to which it is attached. The AASEPDevice checks the type of input 715, whether an ASEPManualAction or a Computer Command is received. When a user performs an ASEPManualAction, the AASEPDevice checks 716 whether the operation requested by the user by performing the ASEPManualAction is valid. If the operation requested is invalid 717, the AASEPDevice displays an error message for the invalid operation, discards the operation, updates registers/memory readable (but not writable by the computer) by the computer to indicate the discarded operation and the reason for discarding the operation and interrupts the computer to which it is attached. If the operation is valid 718, the AASEPDevice prompts 718 the user who performed the ASEPManualAction for the user name and password. When the user enters the user name and password, the user name and password are validated 719. If the validation fails 717, the AASEPDevice displays an error message, discards the operation, updates registers/memory readable (but not writable by the computer) by the computer to indicate the discarded operation and the reason for discarding the operation and interrupts the computer to which it is attached. If the user name and password are valid, the ASEPSoftware checks whether the user has the privilege 720 to perform the operation requested by the user by performing the ASEPManualAction. If the user does not have the required privilege 717, the AASEPDevice displays an error message, discards the operation, updates registers/memory readable (but not writable by the computer) by the computer to indicate the discarded operation and the reason for discarding the operation and interrupts the computer to which it is attached. If the user has the required privilege to perform the operation 721, the AASEPDevice checks whether the operation requested through the ASEPManualAction has conflict with any of the ongoing operations. If the operation requested has conflict 717 with any of the ongoing operations, the AASEPDevice displays an error message, discards the operation, updates registers/memory readable (but not writable by the computer) by the computer to indicate the discarded operation and the reason for discarding the operation and interrupts the computer to which it is attached. If a valid operation requested through the ASEPManualAction by the user does not have any conflicts with any of the ongoing operations 722, the AASEPDevice updates Computer Readable (but not computer writable) Registers/Memory with details of the operation requested through the ASEPManualAction and a unique identifier for the operation and interrupts the Computer to which it is attached. When a Computer Command is received (in this case a computer command is issued when cleanup required for an operation is completed), the AASEPDevice performs 724 the operation identified by the unique identifier, updates registers/memory readable (but not writable) by the computer with the status and results of the operation and interrupts the computer to which it is attached.

There are different algorithms for resolving conflicts between operations in an AASEPDevice, such as priorities, queuing until all prior conflicting operations are completed, etc.

Algorithms used in AASEPDevices for resolving conflicts can use priorities for operations. For example, when a privileged user has initiated a high priority operation and if one conflicting low priority operation is ongoing, the ongoing operation can be marked as inactive and the high priority operation can be kept pending. The inactive operation is discarded and the pending operation is sent to the AASEPDevice device driver by the AASEPDevice as soon as the AASEPDevice device driver sends a command to the AASEPDevice to discard or complete the inactive operation. When an operation is discarded, the computer to which the AASEPDevice is attached, is notified using an interrupt. If the ASEPSoftware has done any cleanup for a discarded operation, part of the cleanup may have to be rolled back depending on the operation. Preferably, only one high priority operation can be kept pending and all other high priority operations are discarded. There are different ways to resolve conflicts between operations based on priorities.

The algorithm used in an AASEPDevice for resolving conflict between new and ongoing operations is implementation specific.

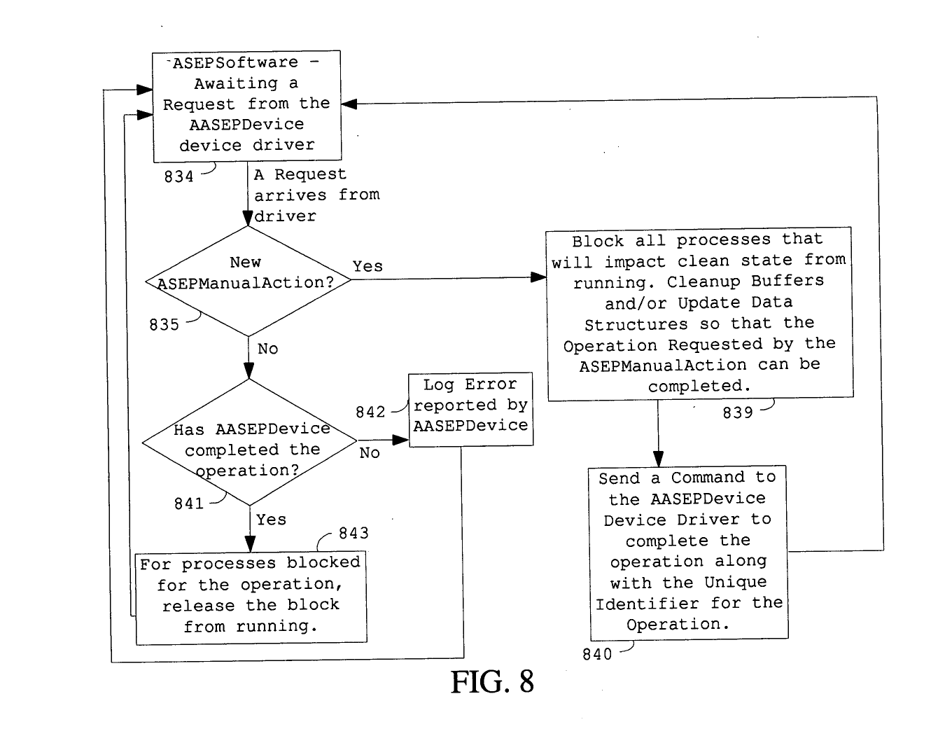

FIG. 8 illustrates an example of a state machine of an ASEPSoftware that can be used with an AASEPDevice that handles conflicts between operations. The ASEPSoftware 834 awaits requests from the AASEPDevice device driver. When a request from the AASEPDevice device driver arrives, the ASEPSoftware checks whether the request is for an operation corresponding to a new ASEPManualAction 835. If the request is for an operation corresponding to a new ASEPManualAction, the ASEPSoftware performs the cleanup 839 required to perform the operation including cleaning up of buffers and updating data structures as required. As part of the cleanup, all processes that will impact the clean state are blocked from running 839. The ASEPSoftware may interact with other operating system modules to get the required cleanup completed. After the clean up is completed, ASEPSoftware sends a command 840 to the AASEPDevice device driver with the unique identifier for the operation so that the AASEPDevice can perform the operation and goes back to the state where it awaits a new request from the AASEPDevice device driver. In this state 840, ASEPSoftware does not release the not-ready-to-run state for processes that will impact the clean state. If the request from the AASEPDevice device driver is not for a new ASEPManualAction 841, ASEPSoftware checks whether the AASEPDevice has completed an operation. When an operation is completed 843, for all the processes that were blocked from running for that operation to complete, the ASEPSoftware releases the block and goes back to the state where it awaits a new request from the AASEPDevice device driver. If the request from the AASEPDevice device driver is to indicate that a user entered an invalid or conflicting operation or that user authentication for an ASEPManualAction failed or that user does not have the privilege required to perform an operation requested by an ASEPManualAction or that an operation was discarded due to conflict with ongoing operations, the ASEPSoftware logs 842 the error message and goes back to the state where it awaits a new request from the AASEPDevice device driver.

There could be one or more AASEPDevices in a computer, each controlling states corresponding to a mutually exclusive set of Application Security Environments or controlling Application Security Environments owned by a mutually exclusive set of users/user-groups or controlling a mutually exclusive set of privileges. Some implementations may use more than one AASEPDevice on the same computer, each controlling states corresponding to sets of Application Security Environments which are not mutually exclusive, but we do not recommend such implementations.

Parts of an AASEPDevice could be embedded in different peripheral or mass-memory devices attached to a computer, such as disks. In this case, a mass-memory device controller can implement privileges based on the current state of the Application Security Environments. This will significantly improve security for mass-memories attached to computers as a malicious user will not be able to copy data from these mass memory devices even if they are stolen.

Optionally, the access restrictions associated with each state of an Application Security Environment is independent of access restrictions associated with other states of the same Application Security Environment. Preferably, access restrictions are such that there are dependencies between access restrictions corresponding to some or all of the states corresponding to an Application Security Environment. This could be achieved by using a bit map as a state where each bit corresponds to a set of privileges and the privileges are enabled or disabled depending on whether the corresponding bit is one or zero. Optionally, the access restrictions for the next state can be created by ANDing or ORing the access restrictions corresponding to the previous state with the access restrictions corresponding to a new selection. Hence, access restrictions may have dependencies on previous states.

Optionally, every process or task or thread can belong to a separate Application Security Environment. In this case, a process identifier or a task identifier or a thread identifier could be used to uniquely identify an Application Security Environment. This may require a user to identify an available process or task identifier, create an Application Security Environment having this identifier and then create a process or task in this Application Security Environment with the same identifier. This implementation requires an operating system that allows a user to select process or task identifiers.

Optionally, an AASEPDevice is such that it allows an ASEPManualAction to change the privileges of an Application Security Environment and does not use Application Security Environment States.

Optionally, there should be an option for users to set a timeout for an ASEPManualAction. At the end of the timeout, if the operation has not been completed, then the user may either let the operation continue or abort the operation.

When an operation requested by a process or task or thread in an Application Security Environment is not permitted by the current state of that Application Security Environment, the process or the task or the thread that attempted to do that privileged operation is put in an error state. The operating system will take appropriate action such as terminating the process or task depending on the error.

Preferably, all or part of the code for the ASEPSoftware, the ASEPImplementers, file system components that use Application Security Environment tags and AASEPDevice device drivers should be kept in Read-Only memory or in memory pages which are write protected to further improve protection. The write protected memories may be a ROM or may be pages or areas of memories marked not writable by an operating system loader; No software including the operating systems running on the computer or an external device should be allowed to change the write protection status for these pages or areas of memories or write into these pages or areas of memories.

Some of the access protection in a computer which is attached to one or more AASEPDevices may be implemented by software other than ASEPImplementers.

If a system allows the configuration to be modified without a user performing an ASEPManualAction, then only the privileged users must have write access to the portion of the configuration containing the list of users, the list of user groups, the list of users in each user group and the privileges of users and user groups. In this case, preferably, the write access to this portion of the configuration must be protected by one or more ASEPImplementers.

If a system allows the configuration to be modified without a user performing an ASEPManualAction then preferably, only a user should have write access to the configuration of each of the Application Security Environments owned by that user. In this case, preferably, the write access to that portion of the configuration must be protected by one or more ASEPImplementers.

If a system allows the configuration to be modified without a user performing an ASEPManualAction then preferably, only members of a user group should have write access to the configuration of each of the Application Security Environments owned by that user group. In this case, preferably, the write access to that portion of the configuration must be protected by one or more ASEPImplementers.

Optionally, some privileged users may have write access to the configuration for other users or to the configurations for groups in which they are not members. In this case, all users need not have write access to configurations. In other words, if privileged users have the privilege to create Application Security Environments and Application Security Environment States for other users, some users need not have the privilege to create Application Security Environments owned by themselves or owned by groups in which they are members.

Preferably, the configuration corresponding to a user or a user group can be fetched using the identifier of the user or the user group. Similarly, the configuration corresponding to an Application Security Environment can be fetched using the identifier of the Application Security Environment. If the device that stores the configuration is a memory or mass-memory device, it is preferable to have a mapping from the identifier of the user/user-group/Application Security Environment to the memory address where the corresponding configuration is stored.

The next state requested by an operation can be hidden from the computer to which an AASEPDevice is attached until the operation is completed. To change the state corresponding to an Application Security Environment, the AASEPDevice can update computer readable registers/memory (which preferably are not writable by the computer) with the identifier of the Application Security Environment, an identifier to identify the state change operation and a unique identifier for the operation and interrupt the computer using a hardware interrupt. Since the new state requested by the ASEPManualAction is not communicated to the computer, no malicious software can control the state of the AASEPDevice corresponding to an Application Security Environment.

The configuration can be kept in AASEPDevice registers/memory which are not writable by the computer to which an AASEPDevice is attached. Since the configuration is kept in registers/memory not writable by software, no malicious software can modify the configuration. This way, highly secure Application Security Environments can be created.

Optionally, an Application Security Environment State corresponds to a set of privileges that the processes/tasks running in the Application Security Environment have while that Application Security Environment is in that state. In this case, an Application Security Environment State is virtual and it is the same as the privileges that the processes/tasks running in the Application Security Environment have while that Application Security Environment is in that state.

Optionally, the effective state of an Application Security Environment can be a combination of the state of a user as proposed in U.S. patent application Ser. Nos. 11/514,807, 11/515,619 and 11/519,178 and the state of an Application Security Environment.

Optionally, the privileges corresponding to an Application Security Environment can be obtained by ANDing the privileges corresponding to a user state and the privileges corresponding to an Application Security Environment State.

Optionally, where privileges are a function of user state, an Application Security Environment can have a fixed set of privileges and need not have multiple states.

Optionally, the configuration can be such that an Application Security Environment State Mapping identifies a set of access restrictions or lack of privileges that the processes/tasks running in an-Application Security Environment have while that Application Security Environment is in that state.

Optionally, the configuration can be such that an Application Security Environment State Mapping identifies a set of both privileges and access restrictions that the processes/tasks running in the Application Security Environment have while that Application Security Environment is in that state.

Preferably, an AASEPDevice allows scripting and the AASEPDevice can emulate an ASEPManualAction as directed by scripts. Optionally, scripts can direct an ASEPManualAction to be emulated by an AASEPDevice at periodic intervals or at a specified date and time.

What is claimed is:

1. A method for implementing security in Application Security Environments in computers where an Application Security Environment is an environment in which one or more processes/tasks can be run and each Application Security Environment is owned by a user or a user group, and more particularly, a method for controlling privileged operations and access to mass-memory devices from processes/tasks/threads running in an Application Security Environment by:
i. Using a device supporting user authentication and supporting one or more Application Security Environments and one or more states for each supported Application Security Environment; This device is referred to as an Authenticating Application Security Environment Protection Device or AASEPDevice; The state of an Application Security Environment is referred to as Application Security Environment State.
ii. The state of an AASEPDevice corresponding to an Application Security Environment is controlled by manual action by a user; The manual action by a user on the AASEPDevice is referred to as Application Security Environment Protection Manual Action or ASEPManualAction;
iii. The AASEPDevice authenticating the user who entered an ASEPManualAction; The AASEPDevice discarding/rejecting the operation requested by an ASEPManualAction if the authentication of the user fails;
iv. The AASEPDevice discarding/rejecting the operation requested through an ASEPManualAction if the user who performed the ASEPManualAction does not have enough privilege to perform the operation requested through the ASEPManualAction;
v. Where each state of an Application Security Environment corresponds to or maps to a set of privileges that the processes/tasks/threads running in that Application Security Environment have when that Application Security Environment is in that state. This mapping is referred to as Application Security Environment State Mapping.
vi. The user or members of the user group who own an Application Security Environment are referred to as Application Security Environment Owners or ASEOs.
vii. Preferably, in addition to supporting an ASEPManualAction that allows a user to the change the state of an Application Security Environment, an AASEPDevice supporting an ASEPManualAction that allows a user to:
a. Create or delete one or more users or
b. Create or delete one or more user groups or
c. Create or delete one or more Application Security Environments for a user or a user group or
d. Create or delete one or more Application Security Environment States for an Application Security Environment or
e. Add users to or remove users from a user group or
f. Divide mass-memories into Regions which can be protected by AASEPDevices or
g. Assign privileges to users and user groups including access to Regions of mass-memories or
h. Create or modify or delete one or more Application Security Environment State Mappings for an Application Security Environment;
viii. Every Application Security Environment being uniquely identifiable; Preferably, each Application Security Environment having a unique identifier in a computer;
ix. A software in the computer to which the AASEPDevice is attached processing requests from the AASEPDevice; This software is referred to as ASEPSoftware;
x. The ASEPSoftware or the AASEPDevice validating an operation requested by a user by performing an ASEPManualAction and discarding/rejecting the operation if it is not a valid operation;
xi. If an operation attempts to create or modify an Application Security Environment State Mapping in such a way that the privileges corresponding to or mapping to the Application Security Environment State exceed the privileges of the user or the user group who owns the Application Security Environment, it is an invalid operation;
xii. The ASEPSoftware or the AASEPDevice verifying whether an operation requested by a user by performing an ASEPManualAction has conflict with any of the ongoing operations, employing a conflict resolution strategy as applicable such that no operations which are active at the same time have conflicts with each other; The conflict resolution strategy may involve discarding some operations or queuing some operations or marking some operations for discarding at a later time.
xiii. The AASEPDevice communicating the operation requested by an ASEPManualAction and any status changes to the operations requested by the ASEPManualAction to the ASEPSoftware using registers/memory readable by the computer to which the AASEPDevice is attached; Preferably, these registers/memory are not writable by the computer;
xiv. The ASEPSoftware sending commands to the AASEPDevice by writing into registers/memory in the AASEPDevice where these registers/memory are writable by the computer to which the AASEPDevice is attached;
xv. Preferably, the AASEPDevice and ASEPSoftware using a unique identifier to identify an operation requested by an ASEPManualAction;
xvi. Preferably, an AASEPDevice device driver processing the interrupts from one or more AASEPDevices and reading the operation requested or any status change for the operation requested by each ASEPManualAction from an AASEPDevice by reading registers/memory in the AASEPDevice; The AASEPDevice device driver sending the operation requested or any status change for the operation requested by each ASEPManualAction along with the unique identifier for the operation requested by the ASEPManualAction to the ASEPSoftware; The AASEPDevice device driver sending commands from the ASEPSoftware to an AASEPDevice by writing into the AASEPDevice registers/memory; Where the AASEPDevice device driver is the software component that controls the AASEPDevice;
xvii. The ASEPSoftware sending a command to perform or discard/reject an operation; If the ASEPSoftware commands the AASEPDevice to perform an operation, the AASEPDevice performing an operation provided it is not marked for discarding due to conflict with an operation from another ASEPManualAction; If the ASEPSoftware commands the AASEPDevice to discard the operation, the AASEPDevice discarding the operation;
xviii. The ASEPSoftware sending a command to discard/reject an operation in the case where the ASEPSoftware is doing validation of the operation and the operation is invalid or in the case where ASEPSoftware is doing operation conflict resolution and the operation has conflict with another operation and the operation is selected for discarding/rejection by the operation conflict resolution strategy;
xix. The ASEPSoftware performing clean up required for an operation if it is not identified for discarding/rejection; The clean up involves blocking all processes/tasks that may impact the clean state from running and updating buffers and data structures;
xx. The ASEPSoftware sending a command to perform an operation to the AASEPDevice if the operation is not discarded/rejected and the clean up for the operation is completed;
xxi. The AASEPDevice updating its registers/memory readable by the computer to which it is attached, when an operation is rejected or completed indicating status;
xxii. The ASEPSoftware releasing the block for processes/tasks which were blocked from running for an operation to complete, after that operation is completed or discarded/rejected by the AASEPDevice;
xxiii. The configuration used by the ASEPSoftware and AASEPDevices consisting of:
a. The list of users;
b. The list of user groups;
c. The list of users in each user group;
d. The privileges for each user and each user group;
e. The list of Application Security Environments owned by each user or user group;
f. The list of states for each Application Security Environment;
g. The list of Regions of mass-memories protected by the AASEPDevices;
h. The Application Security Environment State Mapping for each Application Security Environment State;
xxiv. Preferably, the configuration is stored in the AASEPDevices and the AASEPDevices are capable of identifying the current set of privileges of an Application Security Environment based on the current state of that Application Security Environment;
xxv. Preferably, a computer software module that enforces access restrictions, reading AASEPDevice registers/memory to verify whether a privileged operation requested by a process/task/thread running in an Application Security Environment is permissible as per the Application Security Environment State Mapping for the current state of that Application Security Environment; These software modules that use the privileges corresponding to or mapped to the current state of an Application Security Environment to implement access protection are referred to as ASEPImplementers;
xxvi. Optionally, the ASEPImplementers reading AASEPDevice registers/memory to fetch the current state of the Application Security Environment and the configuration containing the Application Security Environment State Mapping for the current state of the Application Security Environment and enforcing privileges based the current state of the Application Security Environment and the configuration;
xxvii. Preferably, the ASEPImplementers reading the AASEPDevice registers/memory to read the current set of privileges that the processes/tasks/threads running in the Application Security Environment have corresponding to the current state of that Application Security Environment;
xxviii. When the configuration corresponding to the current state of the Application Security Environment does not allow a privileged operation requested by a process/task/thread in the Application Security Environment, the ASEPImplementer putting that process/task/thread in an error state;
xxix. When the configuration corresponding to the current state of the Application Security Environment allows a privileged operation requested by a process/task/thread in the Application Security Environment, the ASEPImplementer allowing the process/task/thread to perform the privileged operation;
xxx. Preferably, mass-memories are divided into Regions such that read or write access to these Regions are part of privileges that can be mapped to an Application Security Environment State;
xxxi. A user or a user group having access to one or more of these Regions of a mass memory or mass memories; The access being further restricted to processes/tasks/threads in Application Security Environments owned by the user or the user group based on the current state of the Application Security Environment and the privileges corresponding to that current Application Security Environment State;
xxxii. Preferably, when a process/task/thread in an Application Security Environment does a file operation permitted by file permissions and the operation maps to a read or write operation to a buffer in the file system buffer cache, the file system verifying whether the read or write access to the Region of mass-memory required by the file operation is permitted by the current set of privileges corresponding to the current state of the Application Security Environment; If the access is not permitted to the Region of mass-memory, the file system returning an error to the process/task/thread that attempted to do the file operation; If the access is permitted, the file system allowing the operation to continue;
xxxiii. Preferably, a file system tagging a read or write request to read or write to a Region in a mass-memory with an identifier for the Application Security Environment so that the storage components below the file system or mass-memory device controllers can verify whether that Application Security Environment has sufficient privileges to do the operation in its current state;
xxxiv. Preferably, when a process/task/thread in an Application Security Environment performs a raw disk read or write, the operating system tagging the raw disk read or write request with the identifier of the Application Security Environment so that storage components or a mass-memory device controller can enforce access protection based on the current state of that Application Security Environment;
xxxv. Optionally, an AASEPDevice being capable of emulating ASEPManualAction and is also allows scripting.

2. An Application Security Environment of claim (1), capable of supporting more than one state such that the privileges of the processes/tasks/threads in an Application Security Environment are dependent on the state of the Application Security Environment; Where an Application Security Environment is an environment in which one or more processes/tasks can be run.

3. An AASEPDevice of claim (1), capable of authenticating a user who performed an ASEPManualAction on that AASEPDevice and also capable of supporting one or more Application Security Environments and one or more states for each Application Security Environment.

4. An AASEPDevice of claim (1), may be made up of hardware or hardware and firmware.

5. The mechanism used by an AASEPDevice of claim (1) for authenticating a user who performed an ASEPManualAction on that AASEPDevice may be based on finger print and/or retina and/or password and/or user name and/or other current or future technologies for user authentication.

6. An device capable of user authentication as claimed in (1) allowing a user to perform all or some of the following operations by performing an ASEPManualAction:
i. Create or delete one or more users or
ii. Create or delete one or more user groups or
iii. Create or delete one or more Application Security Environments owned by a user or a user group or
iv. Create or delete one or more Application Security Environment States for an Application Security Environment or
v. Add users to or remove users from a user group or
vi. Divide mass-memories into Regions which can be protected by AASEPDevices or
vii. Assign privileges to users and user groups including access to Regions of mass-memories or
viii. Create or modify or delete Application Security Environment State Mappings for an Application Security Environment;

7. Preferably, computer readable registers and/or memory in an AASEPDevice of claim (1) containing one or more operations, each requested by a user by performing an ASEPManualAction and the current status of these operations are not writable by the computer.

8. Preferably, computer readable registers and/or memory in an AASEPDevice of claim (1) containing all or part of the configuration are not writable by the computer.

9. Preferably, all or part of the configuration of claim (1) is kept in an AASEPDevice.

10. Preferably, some information relating to an operation requested by an ASEPManualAction of claim (1) such as the next state or a new Application Security Environment State Mapping, can be hidden from the computer to which the AASEPDevice is attached until the operation is completed.

11. A method as claimed in (1), where the ASEPManualAction is a manual action on an AASEPDevice to perform an operation; The ASEPManualAction on an AASEPDevice may be pressing one or more buttons and/or toggling the position of one or more switches and/or turning a wheel and/or changing one or more jumper positions and/or any other manual action accepted by the AASEPDevice.

12. Preferably, an operation requested by an ASEPManualAction of claim (1) is such that the operation is either allowed or not allowed by the configuration.

13. A method as claimed in (1), where the operation request through each ASEPManualAction is assigned a unique identifier.

14. Optionally, an AASEPDevice of claim (1) using a timeout and if the ASEPSoftware does not complete cleanup before the timeout expires, the user being given an option to abort or continue the operation; Optionally, the AASEPDevice allows the user who performed the ASEPManualAction to set this timeout.

15. Preferably, a part of an AASEPDevice of claim (1) is embedded in each peripheral device which is being protected; The peripheral device which has an embedded part of an AASEPDevice may be a mass-memory device; In this case, the controller/firmware of the mass-memory device protecting access to the mass-memory based on the state of Application Security Environments.

16. The configuration of claim (1) being stored in one or more AASEPDevices or one or more other devices attached to the computer to which an AASEPDevice is attached; The configuration may be distributed among different devices; Copies of the configuration may be stored on different devices; The devices attached to the computer storing the configuration may be mass-memories;

17. Optionally, the ASEPImplementers of claim (1) reading AASEPDevice registers/memory to fetch the current state of an Application Security Environment and the configuration containing the Application Security Environment State Mapping for the current state and enforcing privileges based the current state of that Application Security Environment and the configuration.

18. Optionally, only some of the operations below are done by doing an ASEPManualAction on an AASEPDevice of claim (1) by a user:
i. Create or delete a user;
ii. Create or delete a user group;
iii. Create or delete an Application Security Environment for a user or a user group;
iv. Create or delete an Application Security Environment State for an Application Security Environment;
v. Add users to or remove users from a user group;
vi. Divide mass-memories into Regions which can be protected by AASEPDevices;
vii. Assign privileges to users and user groups including access to Regions of mass-memories;
viii. Create or modify or delete an Application Security Environment State Mapping for an Application Security Environment.

19. The ASEPImplementers and ASEPSoftware of claim (1) may use interfaces provided by the AASEPDevice device driver or read AASEPDevice registers/memory directly.

20. Optionally, when the configuration of claim (1) is stored in mass-memories, the Regions of mass-memories where the configuration is stored should be writable only by ASEPSoftware.

21. Preferably, the operation conflict resolution strategies used by an AASEPDevice or ASEPSoftware of claim (1) may result in all new operations which have conflict with ongoing operations to be discarded/rejected.

22. Optionally, the operation conflict resolution strategies used by an AASEPDevice or ASEPSoftware of claim (1) may use priorities for operations such that a new higher priority operation may cause lower priority operations to be discarded/rejected.

23. Optionally, the operation conflict resolution strategies used by an AASEPDevice or ASEPSoftware of claim (1) may result in all new operations that conflict with ongoing operations to be queued for processing until the conflicting operations complete.

24. Optionally, an AASEPDevice and ASEPSoftware of claim (1) have only a subset of the functionalities described in claim (1). For example, an implementation may not use user authentication and/or verify whether the user has enough privilege to perform the operation requested through an ASEPManualAction and/or operation validation and/or operation conflict resolution.

25. Preferably, an AASEPDevice of claim (1) is attached directly or indirectly to the motherboard of a computer. Optionally, an AASEPDevice could be a peripheral device such as a PCI or PCI-X or PCI Express device.

26. Optionally, an AASEPDevice of claim (1) presents itself as a memory to a computer.

27. Preferably, an AASEPDevice of claim (1) will use interrupts to indicate new operations and status changes to the computer to which it is attached.

28. Optionally, an AASEPDevice is such that it allows an ASEPManualAction to change the privileges of an Application Security Environment and does not use Application Security Environment States.

29. Optionally, an AASEPDevice of claim (1) allows scripting and the AASEPDevice is capable of emulating ASEPManualActions as directed by scripts. Optionally, scripts can direct an ASEPManualAction to be emulated by an AASEPDevice at periodic intervals or at a specified date and time.
